(19) United States
(12) Patent Application Publication
(10) Pub. No.: US 2026/0288986 A1
(43) Pub. Date: Sep. 24, 2026

(54) SYSTEMS AND METHODS FOR DYNAMIC DATA ELEMENT TAGGING AND TRACKING

(71) Applicant: Wells Fargo Bank, N.A., San Francisco, CA (US)

(72) Inventors: Naga Jyothi Avusingi, Hydernagar (IN); Peter Bordow, Fountain Hills, AZ (US); Shannon Chang, Tucson, AZ (US); Parul Ghosh, San Francisco, CA (US); Paula Pottle, San Francisco, CA (US); Anita Sukur, Minneapolis, MN (US); Umamaheshwari Thandapani, San Francisco, CA (US); Rick Vosteen, San Francisco, CA (US)

(73) Assignee: Wells Fargo Bank, N.A., San Francisco, CA (US)

(21) Appl. No.: 19/083,192

(22) Filed: Mar. 18, 2025

(51) Int. Cl. G06F 21/62

(52) U.S. Cl. CPC G06F 21/6209; G06F 21/6245; G06F 2221/2137

(57) ABSTRACT

A computing system for imparting security to a data element includes at least one processing circuit. The processing circuit performs operations including receiving the data element; receiving a request to access the data element from a data requestor; tagging the data element with a label regarding the request; determining an expected usage of the data element and storing information regarding the expected usage; providing the data requestor with access to the data element; receiving information regarding an actual usage of the data element; comparing the information regarding the actual usage to the information regarding the expected usage; in response to determining that the actual usage complies with the expected usage, providing a notification regarding a compliance of the actual usage; and in response to determining that the actual usage does not comply with the expected usage, providing a notification regarding non-compliance of the actual usage.

### TECHNICAL FIELD

The present disclosure relates generally to data tagging and tracking, and more specifically to providing an immutable chain of custody for data elements to improve data security and integrity.

### BACKGROUND

Data tagging is a process in data security that refers to assigning metadata or labels to information (e.g., data). Data tagging facilitates effective classification and management of data, enabling systems that are responsible for the data to enforce appropriate security measures for different types of information. For example, sensitive data such as personal identifiers, financial records, or intellectual property can be tagged as “confidential” or “restricted,” ensuring that only authorized personnel can access the sensitive data. Data tagging also supports automated security processes such as encryption, access control, and monitoring by providing clear, standardized classifications that systems can use to detect and mitigate risks. With the proliferation of data in the modern world, fraudsters are continually looking at ways to access and use personal user data. Therefore, providing security to data is desirable.

### SUMMARY

One embodiment relates to a computing system for imparting security to a data element. The computing system includes at least one processing circuit having at least one processor coupled to at least one memory. The at least one memory stores instructions thereon that, when executed by the at least one processor, cause the at least one processing circuit to perform operations including: receiving the data element; receiving a request to access the data element from a data requestor; tagging the data element with a label regarding the request to access the data element; determining an expected usage of the data element based on the request and storing information regarding the expected usage in the at least one memory; providing the data requestor with access to the data element; receiving information regarding an actual usage of the data element by the data requestor; comparing the information regarding the actual usage to the information regarding the expected usage stored by the memory; in response to determining that the actual usage of the data element complies with the expected usage of the data element, generating and providing a notification regarding a compliance of the actual usage of the data element; and in response to determining that the actual usage of the data element does not comply with the expected usage of the data element, generating and providing a notification regarding non-compliance of the actual usage of the data element.

Another embodiment relates to a method for imparting security to a data element. The method includes: receiving, by a computing system, the data element; receiving, by the computing system, a request to access the data element from a data requestor; tagging, by the computing system, the data element with a label regarding the request to access the data element; determining, by the computing system, an expected usage of the data element based on the request and storing information regarding the expected usage in at least one memory of the computing system; providing, by the computing system, the data requestor with access to the data element; receiving, by the computing system, information regarding an actual usage of the data element by the data requestor; comparing, by the computing system, the information regarding the actual usage to the information regarding the expected usage stored by the at least one memory; in response to determining that the actual usage of the data element complies with the expected usage of the data element, generating and providing, by the computing system, a notification regarding a compliance of the actual usage of the data element; and in response to determining that the actual usage of the data element does not comply with the expected usage of the data element, generating and providing, by the computing system, a notification regarding non-compliance of the actual usage of the data element.

Still another embodiment relates to a non-transitory computer-readable medium having instructions stored thereon that, when executed by one or more processors, cause the one or more processors to perform operations. The operations include: receiving a data element; receiving a request to access the data element from a data requestor; tagging the data element with a label regarding the request to access the data element; determining an expected usage of the data element based on the request and storing information regarding the expected usage in at least one memory; providing the data requestor with access to the data element; receiving information regarding an actual usage of the data element by the data requestor; comparing the information regarding the actual usage to the information regarding the expected usage; in response to determining that the actual usage of the data element complies with the expected usage of the data element, generating and providing a notification regarding a compliance of the actual usage of the data element; and in response to determining that the actual usage of the data element does not comply with the expected usage of the data element, generating and providing a notification regarding non-compliance of the actual usage of the data element.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements. Numerous specific details are provided to impart a thorough understanding of embodiments of the subject matter of the present disclosure. The described features of the subject matter of the present disclosure may be combined in any suitable manner in one or more embodiments and/or implementations. In this regard, one or more features of an aspect of the invention may be combined with one or more features of a different aspect of the invention. Moreover, additional features may be recognized in certain embodiments and/or implementations that may not be present in all embodiments or implementations.

### BRIEF DESCRIPTION OF THE DRAWINGS

FIG. 1 is a block diagram of a provider computing system, according to an example embodiment.

FIG. 2 depicts a method of tracking data usage based on data owner preferences, according to an example embodiment.

FIG. 3 depicts a method of performing dynamic data element tagging, according to an example embodiment.

FIG. 4 depicts a method of performing lifecycle data management, according to an example embodiment.

FIG. 5 depicts a graphical user interface, according to an example embodiment.

FIG. 6 depicts another graphical user interface, according to an example embodiment.

### DETAILED DESCRIPTION

In existing systems, tracking the lifecycle of data (e.g., individual data elements, a dataset, etc.) requires extensive effort and processing power. Furthermore, as the data is utilized, there may be unauthorized usages or views that a data owner desires to prevent. There are currently no or little boundaries on how a person's data is used, which creates significant security threats when the person's data is usable or otherwise accessible to outside parties, including unauthorized parties.

The systems, methods, and computer-implemented apparatuses described herein, however, provide a technical solution to at least the aforementioned technical problems present in existing systems. That is, the systems, methods, and computer-implemented apparatuses described herein provide an immutable chain of custody for a dataset and for individual data elements within the dataset. More specifically, the systems, methods, and computer-implemented apparatuses described herein are configured to dynamically tag data elements regarding their requested use (e.g., tokenized requestor information, tokenized use information, etc.) in order to track expected usage of the data. As described herein, the concept of lifecycle management coupled with dynamically tagging the data adds security to usage of the data by requestors. For example, the systems, methods, and computer-implemented apparatuses described herein provide for the specification of use conditions regarding the data (e.g., only virtual use), thereby thwarting unintended and/or undesirable uses of certain data.

Furthermore, the systems, methods, and computer-implemented apparatuses described herein are configured to receive user preferences (e.g., permissions, consents, etc.) regarding their data, track the usage of their data, and provide alerts or other actions based on the tracked usage. In this way, the systems, methods, and computer-implemented apparatuses described herein provide traceability to a person's data, along with conditions that keep a person (e.g., the data owner) apprised of the uses of their data. This is in contrast to current systems that do not allow a user to see how their data is being used (e.g., who is using it and for what reason). This imparts security to a user's data and mitigates against unwanted or undesired data uses.

The systems, methods, and computer-implemented apparatuses described herein may also use artificial intelligence, and in some cases generative artificial intelligence (GAI or gAI), to tag data at different points of use of the data (e.g., in-use, at rest, etc.) in order to dynamically vary the amount of security applied to the data. These dynamic tags may be stored by a backend system so the system can cross-reference when the data is accessed/used with the dynamically changing tag to add security to the data. Furthermore, dummy labels/tags may be used with data so that when those tags/labels are referenced/used subsequent to the application of the labels/tags, the system can cross-check those labels with a number of acceptable uses associated with the stored associated labels in order to track usage of the data and then provide alerts when the number of uses exceeds the predefined number. Using dummy labels/tags may obfuscate the underlying data to impart more security to the data. These and other features and benefits are described more fully herein below.

Before turning to the figures, which illustrate certain example embodiments in detail, it should be understood that the present disclosure is not limited to the details or methodology set forth in the description or illustrated in the figures. It should also be understood that the terminology used herein is for the purpose of description only and should not be regarded as limiting.

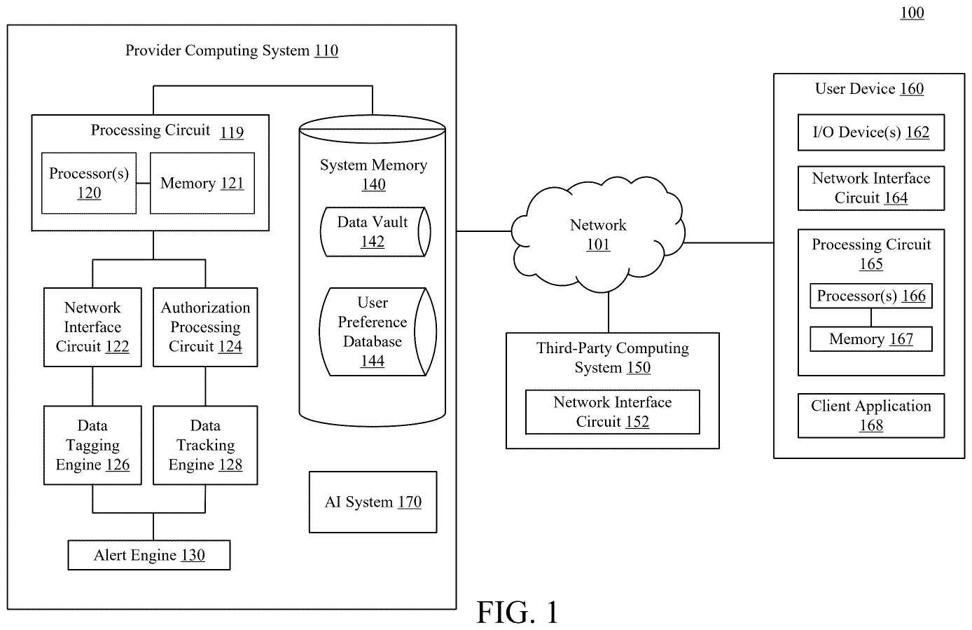

FIG. 1 is a diagram of a computing environment or system 100 for facilitating dynamic data element tagging and management, according to an example embodiment. As shown, the system 100 includes a provider computing system 110, at least one third-party data source/computing system 150 (shown as one third-party computing system 150, but there may be a plurality), and at least one user device 160. The provider computing system 110, the third-party computing system 150, and the user device 160 are in communication with each other and are connected by a network 101.

The network 101 can include any type or form of one or more wired and/or wireless networks. The geographical scope of the network 101 can vary widely and the network 101 can include a body area network (BAN), a personal area network (PAN), a local-area network (LAN), e.g., Intranet, a metropolitan area network (MAN), a wide area network (WAN), or the Internet. The topology of the network 101 can be of any form and can include, e.g., any of the following: point-to-point, bus, star, ring, mesh, or tree. The network 101 can include an overlay network which is virtual and sits on top of one or more layers of other networks. The network 101 can be of any such network topology as known to those ordinarily skilled in the art capable of supporting the operations described herein. The network 101 can utilize different techniques and layers or stacks of protocols, including, e.g., wired and/or wireless protocols, such as the Ethernet protocol, the Internet protocol suite (TCP/IP), the Asynchronous Transfer Mode technique, the SONET (Synchronous Optical Networking) protocol, or the SD (Synchronous Digital Hierarchy) protocol. The TCP/IP Internet protocol suite can include application layer, transport layer, Internet layer (including, e.g., IPv6), or the link layer. The network 101 can include a type of a broadcast network, a telecommunications network, a data communication network, or a computer network.

The provider computing system 110 is owned by, associated with, or otherwise operated by a provider institution (e.g., a bank or other financial institution) that maintains one or more accounts held by various users (e.g., a user associated with the user device 160), such as demand deposit accounts, credit card accounts, receivables accounts, and so on. In the example shown, the provider institution may be a financial institution. In other examples, the provider institution may be another institution or entity that provides various goods and/or services to users and/or customers. In some instances, the provider computing system 110, for example, may include one or more servers, each with one or more processing circuits having one or more processors configured to execute instructions stored in one or more memory devices to send and receive data stored in the one or more memory devices and perform other operations to implement the methods described herein associated with logic or processes shown in the figures. In some instances, the provider computing system 110 may include and/or have various other devices communicably coupled thereto, such as, for example, desktop or laptop computers (e.g., tablet computers), smartphones, wearable devices (e.g., smartwatches), and/or other suitable devices.

In the example shown, the provider computing system 110 includes at least one processing circuit 119, a system memory 140, and an artificial intelligence (AI) system 170. As also shown, the provider computing system 110 includes a network interface circuit 122, an authorization processing circuit 124, a data tagging engine 126, a data tracking engine 128, and an alert engine 130. Although not specifically shown, it may be appreciated that the provider computing system 110 may include one or more I/O devices. The one or more I/O devices are configured to receive inputs from and display information to a user. While the term “I/O” is used, it should be understood that the I/O devices may be input-only devices, output-only devices, and/or a combination of input and output devices.

The processing circuit 119 includes one or more processors 120 coupled to one or more memory device(s). The processing circuit 119 can include, but is not limited to, at least one microcontroller unit (MCU), microprocessor unit (MPU), central processing unit (CPU), graphics processing unit (GPU), physics processing unit (PPU), embedded controller (EC), and/or the like. The processing circuit 119 can include at least one memory 121 operable to store or storing one or more instructions for operating components of the processing circuit 119 and operating components operably coupled to the processing circuit 119. For example, the one or more instructions can include one or more of firmware, software, hardware, operating systems, embedded operating systems. The memory 121 may include one or more devices (e.g., RAM, ROM, Flash memory, hard disk storage) for storing data and/or computer code for completing and/or facilitating the various processes described herein. The memory 121 may include non-transient volatile memory, non-volatile memory, and non-transitory computer storage media, database components, object code components, script components, or any other type of information structure for supporting the various activities and information structures described herein. The provider computing system 110 can include one or more communication bus controllers to effect communication between the processing circuit 119 and the other elements of the provider computing system 110.

In some instances, the network interface circuit 122 includes, for example, program logic that connects the provider computing system 110 to the network 101. The network interface circuit 122 facilitates secure communications between the provider computing system 110 and the user device 160 and the third-party computing system 150. The network interface circuit 122 also facilitates communication with other entities, such as other financial institutions, settlement systems, and so on. The network interface circuit 122 further includes user interface program logic configured to generate and present web pages to users accessing the provider computing system 110 over the network 101 (e.g., from the user device 160).

The network interface circuit 122 may include one or more antennas and associated communications hardware. For example, the network interface circuit 122 may include a network antenna. The network interface circuit 122 further includes any one or more of a cellular transceiver (e.g., CDMA, GSM, LTE, etc.), a wireless network transceiver (e.g., 802.11X, ZigBee, WI-FI, Internet, etc.), and/or a combination thereof (e.g., both a cellular transceiver and a wireless network transceiver).

The authorization processing circuit 124 is structured or configured to perform a variety of functionalities or operations to authorize users accessing the provider computing system 110 and particularly, data or information stored and/or managed by the provider computing system 110. In some embodiments, the authorization processing circuit 124 may utilize various authentication mechanisms such as password verification, biometric scanning, token validation, multi-factor authentication, and so on that control access to the data. More specifically and as described more fully herein below, the authorization processing circuit 124 may be configured to verify an identity of a data owner (e.g., accessing the provider computing system 110 via a client application 168 of the user device 160). Furthermore, the authorization processing circuit 124 may be configured to verify an identity of a data requestor (e.g., accessing the provider computing system 110 via the third-party computing system 150), and the permissions regarding data usage available to the data requestor.

The data tagging engine or circuit 126 is structured or configured to tag data (e.g., stored in the data vault 142). Tagging data refers to applying labels to data elements (e.g., an individual piece of data, a dataset, etc.) that include information relating to the data elements on which the labels are applied. As described in greater detail herein, the data tagging engine 126 may be configured to tag data based on permissions/restrictions regarding data usage as defined by the data owner, contextual information regarding a request to view the data, information regarding previous use of the data, and so on.

The data tracking engine or circuit 128 is structured or configured to perform a variety of functionalities or operations to track usage of data (e.g., data stored in the data vault 142). For instance, the data tracking engine 128 may be configured to monitor a usage of the data after the data is provided to a data requester (e.g., the third-party computing system 150). That is, the data tracking engine 128 may be configured to monitor a usage point of the data, which refers to a point in time post-access to the data (e.g., after the data requestor is approved to access the data, as described below), when the data is being used. In some embodiments, as described in greater detail herein below, the data tracking engine 128 may be configured to determine whether the monitored usage of data complies with an expected usage of data. That is, the expected usage of the data may be defined by one or more tags applied to the data specifying the permissions/restrictions defined by the user along with anticipated usages by the data requestor. For example, where the data is biometric information of the user (e.g., a face scan, an iris scan, a fingerprint scan, etc.), the permissions/restrictions defined by the user may include a permission to use the biometric information for authentication of the user when the user is attempting to access an application (e.g., a mobile application associated with the third-party computing system 150) from the user device 160. Similarly, the user may specify a restriction that prevents use of the of biometric information to authorize payments made from the user device 160. Furthermore, the data requestor may specify the anticipated usage of the biometric information as authentication of the user to provide access to a social media application associated with the data requestor from the user device 160. As such, the tags applied to the biometric information may include “permission to authenticate application from user device,” “payment verification restricted,” and “anticipated usage for granting access to social media application.”

The data tracking engine 128 may compare the actual usage of the data to the expected usage of the data as defined by the tags (e.g., tagged by the data tagging engine 126). In some embodiments, the data tracking engine 128 may monitor usage of the data at the usage point, and may receive a notification of a usage of the data. Furthermore, based on the identified usage, the data tagging engine 126 may be configured to generate a corresponding tag to apply to the data. Additionally or alternatively, the data may be tagged in a version of the data that is stored and kept in the data vault 142. In such instances, the tag may be updated after the data tracking engine 128 determines that the usage of the data has ended. A point when the usage ends and the data element is no longer accessed by the data requestor may be referred to as a check-in or a return point.

For instance, continuing with the example above, the data tracking engine 128 may determine that the data requestor is using the data to authenticate a user attempting to access a social media application from the user device 160. For example and through an API connection, the data tracking engine 128 may receive a notification from the social media application regarding a requested access on behalf of the user. In this case, the data tracking engine 128 may determine that the actual use of the data (e.g., to provide access to the social media application) matches the expected usage of the data as defined by the tags (e.g., being used to authenticate a social media application from a user device, not being used for payment verification). On the other hand, if the data tracking engine 128 determines that the data requestor is using the data to authenticate a user attempting to access a mobile banking application from the user device 160 (e.g., based on a notification from the mobile banking application to the provider computing system), the data tracking engine 128 may determine that the actual use of the data (e.g., to provide access to the mobile banking application) does not match the expected usage of the data as defined by the tags (e.g., being used to authenticate a social media application from user device, not being used for payment verification). As yet another example, if the data tracking engine 128 determines that the data requestor is using the data to verify a purchase from the user device 160 (e.g., based on an API call to the mobile banking application for a payment transaction, based on a notification from the merchant third-party as part of a processing of a payment through a rail, a combination thereof, etc.), the data tracking engine 128 may determine that the actual use of the data (e.g., to verify the purchase) does not match the expected usage of the data as defined by the tags (e.g., being used to authenticate a social media application from user device, not being used for payment verification).

In some embodiments, the data tagging engine 126 may be configured to apply the tags to the data element itself such that when the actual usage of the data element is received (e.g., by the data tracking engine 128), the tag is read relative to the actual usage for comparison of the expected usage to the actual usage. In such instances, the tag may be obfuscated (e.g., represented by binary digits that are unreadable) such that the data requestor is unable to identify the tag while using the data element. Additionally or alternatively, the data tagging engine 126 may be configured to apply the tag to the data element while it is stored in the data vault 142, such that the tag remains stored in the data vault 142 when the data element is in use (e.g., by a data requestor). Then, when the data element is received and the actual usage identified by the data tracking engine 128, the actual usage is compared to the corresponding tag(s) that is stored in the data vault 142. In this way, a fraudster may not be able to identify the expected usage associated with the data element, as the expected usage is not transmitted with the data element, but rather, remains stored in the data vault 142.

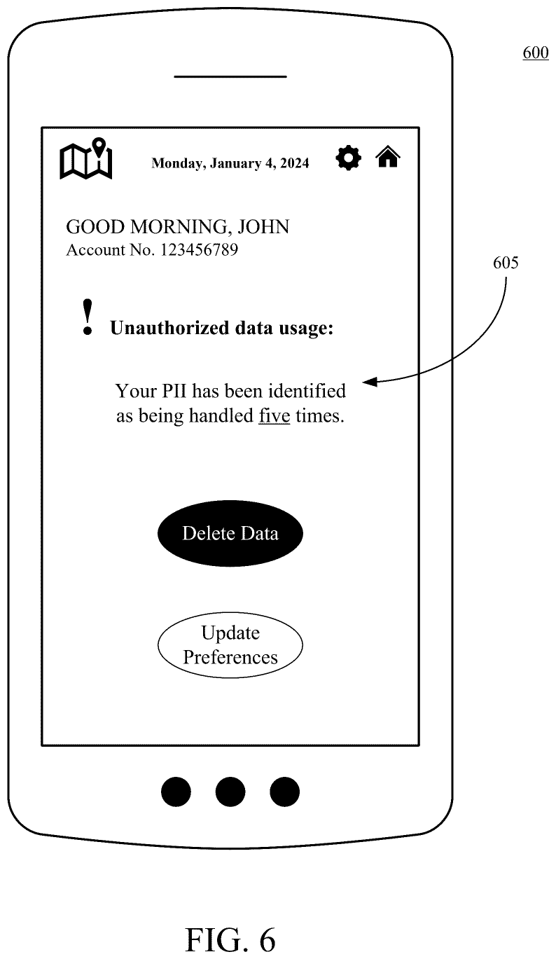

The alert engine or circuit 130 is structured or configured to provide one or more notifications, such as to a data owner regarding usage of their data. More specifically, the alert engine 130 may be configured to receive an indication from the data tracking engine 128 when a usage of the data owner's data does not match the expected usage for the data. The alert engine 130 may be configured to notify the data owner via a plurality of alert mechanisms, depending on notification preferences defined by the data owner. For instance, the alert engine 130 may notify the data owner via a push notification, SMS message, phone call, browser notification, email, and so on. The alert engine 130 may notify the user via the client application 168, as described in greater detail below with reference to FIG. 6.

The system memory 140 (e.g., memory, memory unit, storage device, etc.) may include one or more devices (e.g., RAM, ROM, Flash memory, hard disk storage, etc.) for storing data and/or computer code for completing or facilitating the processes, layers, and modules described in the present application. In this way, in some examples, the memory 121 of the processing circuit 119 may be included with the system memory 140 in some embodiments, and in other embodiments, a separate memory relative to the system memory 140. According to an exemplary embodiment, the system memory 140 is communicably coupled to the processing circuit 119 and includes computer code for executing (e.g., by the processing circuit 119 and/or the one or more processing circuits) one or more processes described herein. The system memory 140 may be or include tangible, non-transient volatile memory or non-volatile memory. The system memory 140 may also include database components, object code components, script components, or any other type of information structure for supporting the activities and information structures described in the present application.

In the example shown, the system memory 140 may further include a data vault 142 and a user preference database 146. In other embodiments, these databases may be separate from the system memory 140.

The data vault 142 is structured or configured as a data or information repository that retrievably stores a plurality of data elements. Each data element refers to a piece of information that is owned by, managed by, and/or associated with a data owner. The data elements may include individual pieces of information (e.g., a name, a date of birth, a facial scan, a fingerprint scan, an iris scan, an account number, and so on). A collection of data elements may be referred to as a dataset. For example, the data element may refer to a user's facial scan (e.g., as an individual piece of information), or the data element may refer to a user's biometric information (e.g., the biometric information being a collective dataset including the user's facial scan, iris scan, fingerprint scan, and so on). Furthermore, the plurality of data elements stored in the data vault 142 may be associated with a data owner (e.g., a user of the user device 160). As mentioned above, the data elements stored in the data vault 142 may include personal identifying information (PII), a phone number, an address, an email address, instant messaging (IM) information, intellectual property, an account number, policy information, etc.

In some embodiments, the data (individual data elements and/or a dataset) may not leave the data vault 142 until the data is protected (e.g., by the data tagging engine 126). Additionally or alternatively, the data in the data vault 142 may be usable prior to being protected, but may not be replicable. In such instances, the data may be only used on the edge itself (e.g., third-party computing system 150 or user device 160), and then may be destroyed following the usage of the data. In this way, the data still would not be leaving the data vault 142. In some embodiments, the provider computing system 110 (e.g., the data tagging engine 126) may be configured to tag the data elements in the data vault 142 to indicate where the data elements came from, who is requesting the data, where the data was sent, how the data is to be used, and other indications regarding usage of the data.

In some embodiments, the data vault 142 may be configured according to at least one of a custodian/library model, a wrapper model, or a data payload model. The configuration may be based on at least one of the data owner preference, the data type, and/or another parameter. For example, highly sensitive data types (e.g., PII or PHI) may be useable in the custodian/library model due to, as described below, the custodian/library model offering a higher level of security compared to the wrapper model or the data payload model.

In the custodian/library model (which may be a construct implemented by the processing circuit 119), for instance, a requestor may “check out” the data from the data vault 142 with agreed usage guidelines. The guidelines may be set by user restrictions/permissions that were received as part of storing the data by the provider computing system 110. In some embodiments, the data owner may reject or approve the request to check out the data. Furthermore, the data owner may specify (e.g., via restrictions and permissions received at process 202 of method 200) that the checked-out data is tokenized, encrypted, etc. For instance, the provider computing system 110 may encrypt the data before it is delivered and send the cryptographic key to the recipient of the data such only the intended recipient can decrypt the data element and use it. A similar or identical approach may be implemented for tokenization or other mechanisms.

The wrapper model generally refers to a software layer or interface between the data requestor and the data vault 142. The wrapper model abstracts and simplifies the interaction with the data vault 142, providing a more user-friendly or unified way to interact with different types of data included in the data vault 142. In the wrapper model, processing circuit 119 may streamline access to the data vault 142, offering a more standardized interface for querying, managing, or manipulating data. In this instance, data may be delivered from the data vault 142 with corresponding permissions and ownership trails (e.g., a header) that wrap the data element. For instance, wrappers can include security features such as authentication, authorization, and access control, which ensure that the data requestor has appropriate permissions to interact with the underlying data.

In the data payload model, the data itself is a payload that includes the permissions and restrictions associated with the data usage. For example, the payload corresponding to a piece of biometric information may include the permissions and restrictions of the biometric information indicated by the data owner. Such permissions and restrictions may include permission to use the biometric information to authorize access to a mobile application, a restriction on using the biometric information to verify a transaction, and so on. In other words, a data requestor receives the payload (e.g., the data being requested) from the data vault 142, the payload including the security features associated with the data (e.g., permissions, restrictions, use conditions, etc.).

The user preference database 144 is a data or information repository structured or configured to retrievably store preferences of users having accounts at the provider institution associated with the provider computing system 110. For instance, the user preference database 144 may store preferences of data owners (users) whose data is stored in the data vault 142. Such preferences may include permissions regarding usage of the data owners'data, restrictions regarding usage of the data owners'data, contact methodology preferences, and so on.

In some embodiments, the user preference database 144 may include one or more files corresponding to each of the users. In such instances, the one or more files may include user information (e.g., permissions regarding usage of the user's data, restrictions regarding usage of the user's data, contact methodology preferences of the user, etc.). Such information stored in the user preference database 144 may be used by the data tagging engine 126 to tag data elements (e.g., stored in the data vault 142), as described above, according to the restrictions and permissions of the user (e.g., the owner of the data elements). For example, the data tagging engine 126 may identify a file in the user preference database 144 that is associated with a data owner of a data element stored in the data vault 142. Then, the data tagging engine 126 may tag the data element based on the permissions and restrictions included in the file associated with the data owner. As described in the example above, if the data element is biometric information of the user, and if the permissions and restrictions include a permission to use the biometric information for granting access to a mobile application and a restriction on using the biometric information for verifying payment information, the data tagging engine 126 may retrieve such information from the user preference database 144 and tag the data element accordingly (e.g., with tags such as “permission to authenticate application,” “payment verification restricted,” etc.).

The AI system 170 may include one or more servers, databases, or cloud computing environments that may execute one or more AI models. The AI models may include, but are not limited to, large language models (LLMs), which can be trained to generate human-like text, speech, images, and/or components of graphical user interfaces. The AI models may be structured using a deep learning architecture that includes a multitude of interconnected layers, including attention mechanisms, self-attention layers, and transformer blocks. The AI models are trained on large datasets to assimilate patterns, structures, and relationships within the data. The trained AI models can be trained to generate outputs that resemble or closely resemble the characteristics of the input data. The AI models may be fine-tuned to generate specific output data, including data that is compatible with various database architectures or provider computing systems. The AI models can be trained via optimization of a large number of parameters, in which the AI models learn to minimize the error between its predictions and the actual data points, resulting in highly accurate and coherent generative capabilities.

As described herein, the AI system 170 may include a GAI model. The GAI model refers to an artificial intelligence model(s) configured to generate or output data in response to prompts or requests. The GAI model may include an AI model(s) configured to analyze, interpret, or generate outputs based on complex graphical data structures, such as hairball graphs, using natural language processing (NLP) or other techniques. That is, the GAI model may be configured to identify relationships between nodes, generate ontologies to describe data structures, and/or cluster related data points based on learned patterns. Further, the GAI model may be configured to generate visual elements such as graphs and textual elements such as summaries or explanations of complex graphical data for graph interpretation. In addition, the GAI model may be configured to update complex graphs or corresponding data based on newly received data (e.g., via a supplemental input of a user) and/or training (e.g., using a training dataset, an updated training dataset, or additional training data). In some arrangements, the GAI model may be trained using a training dataset (e.g., a dataset associated with the provider).

In some arrangements, the GAI model may include at least one LLM. As mentioned above, the LLM refers to an artificial intelligence model trained on large datasets (e.g., text data) and configured to interpret and generate human-like text responses to user queries or prompts. In one embodiment, the LLM and/or the GAI model may generate visual elements (e.g., the complex graph, subsets or summaries of the graph, word clouds, etc.) using GAI systems configured to process and output graphics, such as DALL-E. In some examples, the LLM and/or the GAI model may be configured or trained to interpret a complex graph generated by another system. For example, the GAI model may analyze complex graphical data, such as a hairball graph including one or more interconnected nodes, by using LLM to determine an ontology defining relationships between the data represented by the nodes. In other examples, the GAI model and/or LLM may generate or create an ontology based on concepts included in provided materials (e.g., documents including information related to data-usage). Further, the GAI model and/or LLM may identify an existing ontology corresponding with an existing dataset that may be stored (e.g., in system memory 140) for later retrieval and usage.

More specifically, the GAI model may be configured to create labels at each point-in-time and/or use of the data. That is, the labels of the data may include when the data is at rest, when the data is in-use, etc. As such, there may be unique permissions or restrictions associated with the data when the data is at-rest as compared to when the data is in-use. For example, when the data is at-rest, the data may be labeled using a dummy label. Additionally or alternatively, when the data is in-use, the dummy label may be removed from the data. In this way, sensitive information may be obfuscated when it is not in-use such that the information is secured against potential security threats to data while at-rest. In some embodiments, the GAI model may use contextual information to create such labels. For example, the contextual information may be used when a customer is withdrawing resources and moving the resources to different locations. In this instance, if the customer provides an input indicating a preference to not share the user's data, then the GAI model may label the data as such.

As another example, the GAI model may be configured to tag the data element at an access point in time (e.g., when the data element is accessible by the data requestor), at a usage point in time (e.g., when the data element is being used by the data requestor), or at a check-in point in time (e.g., when the data requestor returns the data element after usage). In this way, the data tracking engine 128 may be configured to track the data element to determine a compliance at the access point in time, the usage point in time, and the check-in point in time. Furthermore, the data tracking engine 128 may be configured to generate a tracking map for the data element, where the tracking map represents the compliance of the usage of the data element at the access point in time, the usage point in time, and the check-in point in time. The tracking map may be a depiction of the data element over time and/or use to show how the data element has been used and whether usage has complied with expected usage, which may impact the integrity value of the data element.

Furthermore, the GAI model may categorize high value, low value, etc., data elements (e.g., stored in the data vault 142). As an example, highly sensitive information such as passwords, biometric information, PII, etc. may be high-value data elements, while information such as an email address or a phone number may be low value data elements. In some embodiments, the GAI model may be configured to categorize the data elements as such (e.g., high-value, low-value, etc.) by determining a consequence of an unauthorized use of the data. For instance, unauthorized use of a phone number may have a less extreme consequence than unauthorized use of biometric information (which may be used to verify payments, for example). Therefore, in this instance, the GAI model may categorize the biometric information as high-value data elements, while the phone number may be categorized as a low-value data element.

In some embodiments, the GAI model may tag data by training models with sensitive data elements removed. Thus, the training data may be based on non-sensitized data yet applied to sensitive data due to inferential mapping. For example, the GAI model may be trained using data elements stored in the data vault 142. Prior to leaving the data vault 142, however, in order to be used as training data by the GAI model, sensitive data elements may be removed from the data elements. That is, the authorization processing circuit 124 may identify that the AI system 170 is attempting to access data from the data vault 142 for training purposes (e.g., training of the GAI model). Then, the authorization processing circuit 124 may grant the AI system 170 access to non-sensitized data from the data vault 142. The non-sensitized data may refer to genericized versions of the data elements stored in the data vault 142. For example, if the AI system 170 requests access to biometric data from the data vault 142 for training the GAI model, sensitive information such as an actual facial scan, an actual fingerprint scan, an actual iris scan, and so on, may be removed from the data elements such that the data elements provided to the AI system 170 (e.g., by the authorization processing circuit 124) are generic (e.g., non-sensitized) pieces of biometric information such as “a facial scan” (e.g., without the actual facial scan), “a fingerprint scan” (e.g., without the actual fingerprint scan), “an iris scan” (e.g., without the actual iris scan), and so on.

In some embodiments, the system 100 may include one or more third-party computing systems 150. The third-party computing system 150 may refer to a computing system that is external to the provider computing system 110. In some embodiments, the system 100 may include a plurality of third-party computing systems 150 associated with a plurality of third-party entities. The third-party entity refers to another entity (e.g., another provider entity, such as another financial institution) that is a third-party relative to the provider institution. In some embodiments, the entity associated with the third-party computing system 150 may be an entity requesting access to or use of data stored in the data vault 142 and owned by a data owner (e.g., a user of the user device 160).

The third-party computing system 150 may include the network interface circuit 152, which may be similar/identical to the network interface circuit 122 of the provider computing system 110, as described above. For example, the network interface circuit 152 includes program logic and various devices (e.g., transceivers, etc.) that connect the third-party computing system 150 to the network 101. In some instances, the program logic interfaces with one or more transceivers (e.g., Bluetooth, Wi-Fi, or any other suitable communication transceivers) to enable connection with the network 101. The network interface circuit 152 facilitates secure communications between the third-party computing system 150 and the provider computing system 110. The network interface circuit 152 also facilitates communication with other entities, such as other financial institutions, settlement systems, and so on (e.g., the provider computing system 110, the user device 160, etc.).

The user device 160 is owned, operated, controlled, managed, and/or otherwise associated with a user. In the example shown, the user is a customer of the provider institution. As such, the user may have one or more accounts that are stored at the provider computing system 110. In some embodiments, the user device 160 may be or may include, for example, a desktop or laptop computer (e.g., a tablet computer), a smartphone, a wearable device (e.g., a smartwatch), a personal digital assistant, and/or any other suitable computing device. In the example shown, the user device 160 is structured as a mobile computing device, namely a smartphone. A user of the user device 160 may refer to the data owner. In this way, the user of the user device 160 may have access to information (e.g., data tags) stored by the provider computing system 110 regarding the data owner's data.

In some embodiments, the user device 160 includes one or more I/O devices 162, a network interface circuit 164, at least one processing circuit 165, and at least one client application 168. Again, while the term “I/O” is used, it should be understood that the I/O devices 162 may be input-only devices, output-only devices, and/or a combination of input and output devices. In some instances, the I/O devices 162 include various devices that provide perceptible outputs (such as display devices with display screens and/or light sources for visually-perceptible elements, an audio speaker for audible elements, and haptics or vibration devices for perceptible signaling via touch, etc.), that capture ambient sights and sounds (such as digital cameras, microphones, etc.), and/or that allow the customer to provide inputs (such as a touchscreen display, stylus, keyboard, force sensor for sensing pressure on a display screen, etc.). In some instances, the I/O devices 162 further include one or more user interfaces (devices or components that interface with the customer), which may include one or more biometric sensors (such as a fingerprint reader, a face scanner, an iris scanner, etc.).

The network interface circuit 164 includes, for example, program logic and various devices (e.g., transceivers, etc.) that connect the user device 160 to the network 101. The network interface circuit 164 facilitates secure communications between the user device 160 and each of the provider computing system 110 and the third-party computing systems 150. The network interface circuit 164 also facilitates communication with other entities, such as other financial institutions, settlement systems, and so on.

In some embodiments, the user device 160 may include a processing circuit 165. The processing circuit 165 includes one or more processors 166 coupled to one or more memory device(s). The processing circuit 165 can include, but is not limited to, at least one microcontroller unit (MCU), microprocessor unit (MPU), central processing unit (CPU), graphics processing unit (GPU), physics processing unit (PPU), embedded controller (EC), and/or the like. The processing circuit 165 can include at least one memory 167 operable to store or storing one or more instructions for operating components of the processing circuit 165 and operating components operably coupled to the processing circuit 165. For example, the one or more instructions can include one or more of firmware, software, hardware, operating systems, embedded operating systems. The memory 167 may include one or more devices (e.g., RAM, ROM, Flash memory, hard disk storage) for storing data and/or computer code for completing and/or facilitating the various processes described herein. The memory 167 may include non-transient volatile memory, non-volatile memory, and non-transitory computer storage media, database components, object code components, script components, or any other type of information structure for supporting the various activities and information structures described herein.

In one embodiment, the user device 160 stores in the memory 167 and executes (“runs”) using the one or more processor(s) 166, the client application 168. The user device 160 may also execute a variety of other applications, such as an Internet browser application, a text messaging application (e.g., for sending MMS or SMS to the provider computing system 110 and/or the third-party computing system 150), and/or an application provided or authorized by entities implementing or administering certain of the operations described herein.

In the example shown, the client application 168 is a provider institution client application provided by and at least partly supported by the provider computing system 110 (e.g., a financial institution banking application, such as a mobile banking application). For example, in some instances, the client application 168 is coupled to the provider computing system 110 and may enable the user to perform various user activities (e.g., account management, account opening and/or closing actions, account withdrawals and deposits) and/or perform various transactions (e.g., the customer sending funds to a recipient, the customer receiving funds from a sender, etc.) associated with one or more user accounts of the user held at the provider institution associated with the provider computing system 110. For instance, the user of the user device 160 may access information regarding their data via the client application 168. In this way, the user (e.g., data owner) may be able to track and therefore know how their data is being used via the client application 168.

Furthermore, the provider computing system 110 (e.g., the data tagging engine 126) may be configured to generate a multi-dimensional view of each data element/field for display on the user device 160 via the client application 168. As an example, the multi-dimensional view may be a cube including multiple data elements that have various properties associated with each element. Continuing with this example, the cube may include multiple pieces of contact information (e.g., name, address, email address, phone number, etc.) owned by the user of the user device 160. Therefore, each face of the cube may depict one of the multiple pieces of contact information, including any properties associated with the piece of contact information. The properties may include a permission, a restriction, a use condition, and so on, associated with the piece of contact information.

The client application 168 provided by the provider computing system 110 may additionally be coupled to the third-party computing system 150 (e.g., via one or more API(s) and/or software development kits (SDKs)) to integrate one or more features or services provided by the third-party computing system 150. Accordingly, the client application 168 is structured to provide the user with access to various services offered by the provider institution and/or the third-party provider.

In some embodiments, the client application 168 is hard coded into the memory of the user device 160. In some other embodiments, the client application 168 is a web-based interface application, where the user has to log onto or access the web-based interface before usage.

With an example structure of the system 100 being described above, example processes performable by the system 100 (or components/systems thereof) are described below. It should be appreciated that the following processes are provided as examples and are in no way meant to be limiting. Additionally, various method processes discussed herein may be performed in a different order or, in some instances, completely omitted. These variations have been contemplated and are within the scope of the present disclosure.

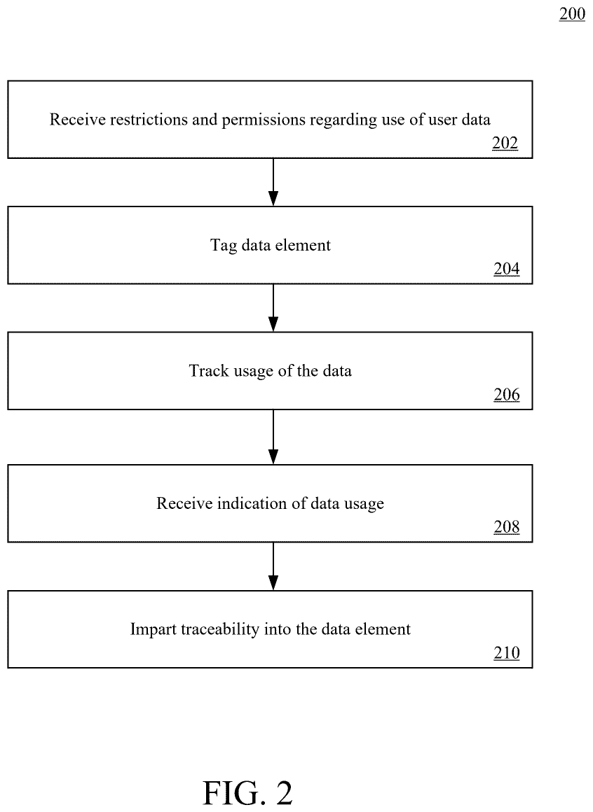

Referring now to FIG. 2, a flow diagram of a method 200 for tracking data usage based on data owner preferences is shown, according to an example embodiment. Various operations of the method 200 may be conducted by the system 100 and particularly parts thereof (e.g., the provider computing system 110, the third-party computing system 150, the user device 160). It should be understood that not all method steps/processes may be performed to “complete” the method. Certain steps/processes may be omitted in other embodiments, and still fall within the scope of the present disclosure.

As a brief overview, the method 200 refers to a method of personalizing and tracking data elements based on preferences of the data owners. That is, the data owner provides restrictions and permissions regarding usage of their data, and such permissions and restrictions are applied to the data using tags. For example, the data owner may permit virtual use of contact information, but may restrict local use of contact information. In this example, the contact information (e.g., as a collective dataset and/or each individual piece of contact information) may be tagged as “virtual use only” and “local use restricted.” Then, the usage of the data may be tracked and traceability imparted into the data. Thus, the method 200 provides a method of securing data usage based on personal preferences of the data owner, and facilitates tracking usage of the data.

Although not shown in FIG. 2, the method 200 may include the provider computing system 110 communicatively coupling to the user device 160 (e.g., via the network 101). In this way, the provider computing system 110 may be configured to utilize data streams from the user device 160 to perform activities, as described herein, that are not well-understood, routine, or conventional. In some embodiments, the provider computing system 110 communicatively couples with the user device 160 by receiving at least one credential (e.g., a password, a PIN, a biometric scan, a user ID, etc.) associated with the user (e.g., a data owner of data stored in the data vault 142). For example, the provider computing system 110 may receive, as an input from the user via the client application 168, a PIN unique to the user and utilized by the provider computing system 110 to identify the user. The provider computing system 110 (e.g., the authorization processing circuit 124) may be configured to authorize the credential. Once the user is authenticated, the provider computing system 110 may be configured to access account information (e.g., stored in the system memory 140) associated with the user.

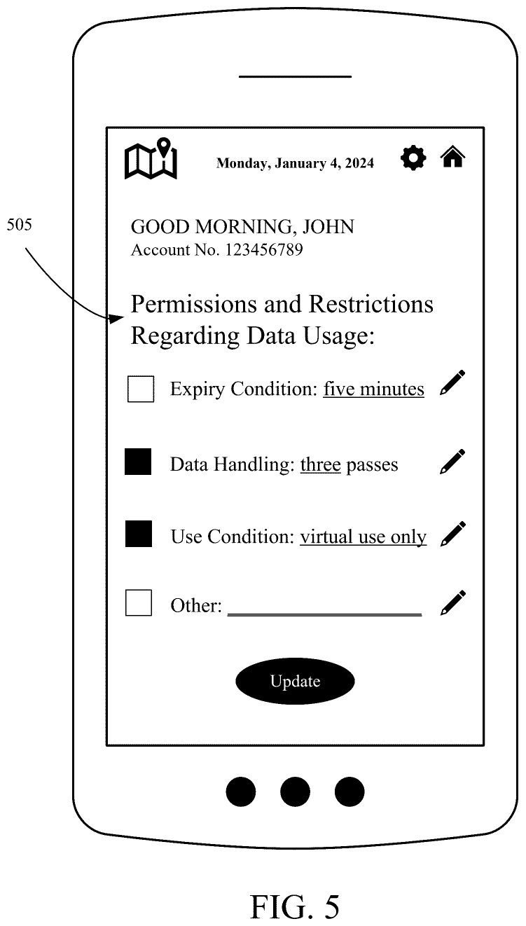

As shown in FIG. 2, the method 200 may include the provider computing system 110 receiving at least one restriction or permission regarding usage of user data at process 202. The user data refers to data stored in the data vault 142 of which the authorized user is associated with (e.g., owns) and/or manages. For instance, the user data may be one or more data elements, or collectively a dataset. As such, the user data may include, but is not limited to, any of personal identifying information (PII) such as a phone number, an address, an email address, instant messaging (IM) information, an account number, policy information, etc. In some instances, the data may be other types of information, such as intellectual property information associated with the user (e.g., a corporation that owns patents). In this regard, it should be appreciated that the data types are highly variable. In some embodiments, the at least one restriction or permission may be received from the user via graphical user interface (GUI) 500 presented on the user device 160, as described below with reference to FIG. 5. Furthermore, once received, the restrictions and/or permissions may be stored in the user preference database 146. As an example, a restriction received at process 202 may include a threshold number of times that the data may be accessed (e.g., the data cannot be accessed more than a predefined number of instances, such as ten times).

In some embodiments, the provider computing system 110 may simulate data misuse during process 202. More specifically, the simulated data misuse may refer to simulations in which an artificial data element (e.g., artificial identifying information (PII), phone number, address, email address, instant messaging (IM) information, intellectual property, account number, policy information, etc.) is provided to an artificial data requestor. Furthermore, the simulations may include varying levels of security applied to the artificial data element to demonstrate the consequences of granting the artificial data requestor access to the artificial data element. For instance, a first simulation may include granting an artificial data requestor access to artificial policy information, where the artificial policy information is permitted to be used locally by the artificial data requestor. Then, a second simulation may include granting an artificial data requestor access to artificial policy information, where the artificial policy information is only permitted to be used virtually by the artificial data requestor. The provider computing system 110 may present consequences (e.g., how the artificial data requestor may use the data based on the permissions, where the data may be used, etc.) of the first simulation and the second simulation. For instance, in the first simulation, the artificial policy information may be misused after the artificial data requestor is granted local access to the artificial policy information, whereas in the second simulation, the artificial policy information may be properly used after the artificial data requestor is granted virtual access to the artificial policy information. In this way, the simulation of data misuse may be used by the provider computing system 110 to demonstrate the importance of protecting certain types of data to the user. The simulation may be performed using one or more generative AI models.

After receiving the restrictions and/or permissions at process 202, the provider computing system 110 (e.g., the data tagging engine 126) may be configured to tag one or more data elements according to the restrictions and/or permissions. That is, the provider computing system 110 may apply the tags to data stored in the data vault 142 of which the user is the data owner. As described herein, data tagging refers to labeling data with additional information. In this instance, the additional information (i.e., data tag) refers to a label or tag that identifies at least one of the restrictions and/or permissions regarding the usage of the data received from the data owner at process 202. For example, where the data is contact information of the user (e.g., an address, an email address, a phone number, etc.), the permissions/restrictions defined by the user may include a permission to use the contact information to contact the user regarding a transaction made by the user. Similarly, the user may specify a restriction that prevents use of the of contact to contact the user regarding an advertisement. As such, the tags applied to the contact information may include “permission to contact for transactions” and “contacting for advertisements restricted.” In some instances, the data tagging engine may use one or more of a variety of data security tools to tag the data such as hashing, tokenization, etc.

In some embodiments, the data tagging engine 126 may be configured to tag individual data elements or a collective set of data elements (i.e., a dataset). In this way, the data tracking engine 128 may be configured to track data usage and determine an individual compliance regarding the usage of the individual data elements and/or determine a collective compliance regarding the usage of the dataset. For example, the data tracking engine 128 may be configured to determine that the usage of an individual data element within the dataset is non-compliant, which may result in the data tracking engine 128 determining a non-compliant usage of the dataset. Additionally or alternatively, the data tracking engine 128 may be configured to determine that the usage of the dataset is non-compliant. Therefore, the integrity value associated with a dataset may be determined based on compliance of the dataset as a whole and/or compliance of the individual data elements within the dataset. Such a system for tracking data elements provides a multi-level verification of data usage, including monitoring for compliance at the level of individual data elements and at the level of the collective dataset.

As mentioned above, individual data elements may include individual pieces of information (e.g., a name, a date of birth, a facial scan, a fingerprint scan, an iris scan, an account number, and so on). The collective set of data elements refers to a group of individual data elements (e.g., biometric information, contact information, PII, etc.). For example, an individual data element may be a user's facial scan, which may be included in the collective data of biometric data (e.g., including the user's facial scan, a fingerprint scan, an iris scan, etc.). As another example, an individual data element may be a user's address, which may be included in the collective set of contact information (e.g., including the user's address, an email address, a phone number, etc.). Therefore, the data tagging engine 126 may be configured to tag the data elements individually (e.g., tagging each of the facial scan, the fingerprint scan, and the iris scan, tagging each of the address, the email address, and the phone number, etc.) or the data tagging engine 126 may be configured to tag the collective set of data elements (e.g., tagging the biometric information, tagging the contact information, etc.).

Moreover, the tags applied at process 204 may be persistent tags applied to the data elements such that subsequent parties (e.g., a user accessing the data via the third-party computing system 150) using the data may be aware of limitations regarding how the data may be used. In this way, rather than merely associating a category with the data element, the persistent tags are configured to define use conditions for the data element as well. For example, the persistent tags may include permissions or restrictions for use of the data defined by the data owner. In this way, the use conditions for the data element may be defined by the permissions or restrictions indicated by the data owner. As another example, the use conditions may be defined by the provider computing system 110. For instance, the provider computing system 110 may define a use condition regarding where the data may or may not be used (e.g., virtually, locally, etc.). In some embodiments, different structures of the data vault 142 (e.g., the custodian / library model, the wrapper model, the data payload model, etc.) may be configured such that the data elements stored therein are automatically applied one or more use conditions (e.g., the data element can only be provided as a copy, the data element can only be used virtually, etc.).

Once the data is tagged at process 204, the provider computing system 110 (e.g., the data tracking engine 128) may be configured to track usage of the data at process 206. For instance, the data tracking engine 128 may identify when a user is selectively granted access to the data element in the data vault 142. In such instances, each access provision may be tracked by the data tracking engine 128 as a use of the data element.

Additionally or alternatively, tracking usage of the data at process 206 may include utilization of a blockchain hash. Distributed ledgers, such as blockchains, are designed to store data across multiple nodes or systems, instead of in a centralized database. In various arrangements, broadcasting can include the process of distributing or propagating the data structure across a network (e.g., blockchain network). As used herein, “on-chain” refers to data that is stored on the blockchain or distributed ledger. Moreover, the data tracking engine 128 may be configured to obfuscate the data stored on the blockchain. In creating these obfuscated data structures, the data tracking engine 128 might utilize a technique such as hashing. Hashing transforms the input data into a fixed-size string of characters, which does not reveal any information about the input data itself. In this way, usage of the data elements that are stored in the data vault 142 may be hashed and recorded on the blockchain by the data tracking engine 128.

In some embodiments, the provider computing system 110 may receive an indication of data usage at process 208. Furthermore, the provider computing system 110 (e.g., the alert engine 130) may provide an alert to a data owner (e.g., to the user device 160 via the client application) based on the received indication of data usage. More specifically, the alert may be provided to the data owner via GUI 600, as described below with reference to FIG. 6. For example, if the data is used multiple times, the alert engine 130 may provide a call or other message to the data owner (e.g., to the user device 160 associated with the data owner). In this instance, the provider computing system 110 may confirm the contact methodology relative to the received permissions. As a more specific example, the provider computing system 110 may alert the data owner if the data is accessed (e.g., passed) more than a predefined number of times (e.g., the predefined number of times being a restriction received at process 202). Similarly, the provider computing system 110 may alert the data owner if the data is being used in contrast to the stated use indicated in the permissions received at process 202.

To track the data once it is transferred to a recipient, however, the provider computing system 110 may impart traceability into the data element at process 210. In some embodiments, imparting traceability at process 210 may include imparting one or more indicators (e.g., dummy labels) into the data element. Thus, if the dummy label or other indicator is received/detected in the future as being associated with an unintended use, the provider computing system 110 may alert the data owner. For example, a data owner may specify that their account number is only permitted to be used virtually. The data tagging engine 126 may apply a tag indicating “virtual use only” and a dummy label (e.g., “Account A”) to the data element (e.g., the account number). Then, if the data tracking engine 128 identifies that “Account A” has been used locally (e.g., the account number has been stored on a physical device or other hardware), the data owner may be alerted (e.g., by the alert engine 130) of the unintended use of the data owner's account number. More specifically, the data tracking engine 128 may be configured to monitor a usage of the data tagged as “Account A” once the data leaves the data vault 142. Therefore, even though the data requestor has been granted access to the data element (e.g., the account number), the data tracking engine 128 continues to monitor the data by tracking the data tagged as “Account A.” Then, if the data tracking engine 128 identifies a non-virtual use of the data element tagged as “Account A,” the data tracking engine 128 may determine that the non-virtual use of the data element is non-compliant and may notify the data owner.

Furthermore, process 210 may include categorizing the data using labels for tracking purposes. Then, based on the category, the provider computing system 110 may apply different protection layers to the data. In some instances, the provider computing system 110 may include the GAI model (e.g., the AI system 170) configured to automatically categorize data, making data categorization more efficient.

In some instances, each reuse of the data may include an integrity value. In some embodiments, the integrity value may be generated by the data tracking engine 128 based on the monitored usage of the data, and may be applied as a value at the end of the data label. That is, the integrity value refers to an indicator of whether the prior use of the data was as expected (e.g., based on the information regarding the request for the prior use of the data). In this way, the integrity value may provide security to the chain of use of the data. For example, the integrity value may provide an indication that the data was previously used by an unauthorized party. In some embodiments, the integrity value may be based on prior usage of the data to assess whether an expected usage of the data indicates that the data may be used by an unauthorized party or for another unauthorized reason. This integrity value is an indicator whether the prior use was as expected in order to provide security to the chain of use (i.e., indicate that the data was unlikely used by unauthorized parties). In this regard, the integrity value represents whether usage of the data aligns with the expected usage of the data.

In some embodiments, the expected usage may include a set of expected usages (e.g., the data may be used for authenticating a social media application, a mobile banking application, an online shopping application, a streaming service, etc.). Then, if the data tracking engine 128 determines that the actual usage of the data does not match the set of expected usages, the data tracking engine 128 may assign a lower integrity value than if the actual usage of the data does match the set of expected usages. In response to the lower integrity value, the data tagging engine 126 may be configured to update the set of expected usages associated with the data such that the updated set of expected usages is smaller than the initial set of expected usages (e.g., the updated set of expected usages including authenticating the social media application, the online shopping application, or the streaming service, and not authenticating the mobile banking application). In this way, the provider computing system 110 (e.g., the data tracking engine 128, the data tagging engine 126, etc.) responds to the lower integrity value (e.g., indicating misuse, unauthorized use, malicious use, etc.) of the data by narrowing the permissible usages of the data and thereby applying additional security measures to bolster the integrity (e.g., trustworthiness, reliability, etc.) of the data.

For example, if usage of the data does align with the expected usage, the data may be assigned a high integrity value, and if usage of the data does not align with the expected usage, a system may assign a low integrity value. In this way, the integrity value represents a level of reliability/trustworthiness regarding the data (e.g., whether the data was previously mishandled/misused, whether the data may be associated with malicious data, etc.). Therefore, data owners and data requestors may be aware of the level of security regarding the data their own and request to access, respectively. In some embodiments, the data tracking engine 128 may be configured to notify the data owner to confirm an adjustment to the integrity value associated with the data owner's data. Additionally or alternatively, in some instances, data stored in the data vault 142 that are associated with an integrity value above a predefined threshold may be used a training data (e.g., for the AI system 170), because the integrity value being above the predefined threshold indicates that the associated data is more secure/trustworthy (e.g., not previously mishandled nor misused, not malicious, etc.) than data associated with an integrity value that is not above the predefined threshold.

More specifically, if the data tracking engine 128 identifies that an expected usage (e.g., based on the tags applied by the tagging engine 126, as described above) of a user's biometric information is for granting access to a mobile application, and then determines that the actual usage of the biometric information is for payment verification, the biometric information may be assigned a low integrity value (e.g., 1, on a scale of 1 to 10). For example, the data element may be a birthdate and be reflected as follows, with (IV) representing the integrity value that was applied to the data element: hash[ddmmyyyy](IV). This is showing the integrity value applied to an individual data element, but similar processes may be used with a dataset. In this example, the biometric information may refer to a collective set of biometric information (e.g., including a facial scan, a fingerprint scan, an iris scan, etc.) or individual pieces of biometric information (e.g., the facial scan, the fingerprint scan, the iris scan, etc.). In other words, the data tracking engine 128 may be configured to apply the integrity value to individual pieces of data or to a collective set of data.

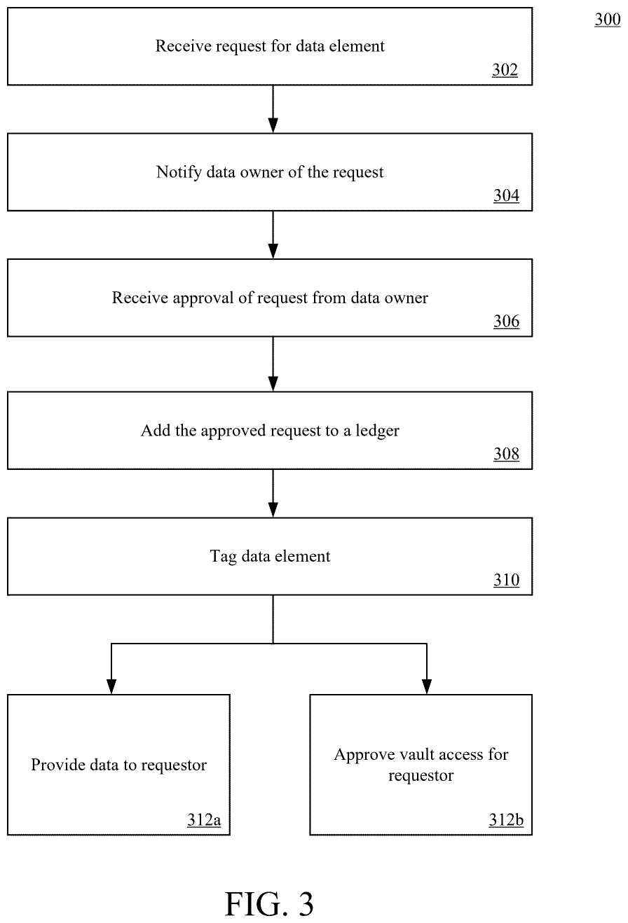

Referring now to FIG. 3, a method 300 for performing dynamic data element tagging is shown, according to an example embodiment. Various operations of the method 300 may be conducted by the system 100 and particularly parts thereof (e.g., the provider computing system 110, the third-party computing system 150, the user device 160). It should be understood that not all method steps/processes may be performed to “complete” the method. Certain steps / processes may be omitted in other embodiments, and still fall within the scope of the present disclosure.

As a brief overview, the method 300 refers to a method of providing data to a data requestor in response to receiving a request for such data. That is, the data owner may be notified of the request for the data, and the data owner may then approve the request for the data. For example, the data requestor may request access to biometric information of a user, and the data owner may approve the received request. The approved request may then be added to a ledger, and the data element may be tagged. For example, the data element may be tagged according to information included in the request (e.g., “anticipated use for application log-in,” “not permitted for payment verification,” etc.). Then, the data may be directly provided to the data requestor, or the data requestor may receive access to a vault in which the data is stored. Thus, the method 300 provides a method of receiving a request to access data and providing secured access to the data.

As shown in FIG. 3, the provider computing system 110 may receive a request for a data element from the data vault 142 at process 302. In some instances, the request received at process 302 may include contextual information regarding the request such as an identity of the requester, a reason for the request, an estimated length of time for use of the data, where the data may be used and an agreement to not use for more stuff/uses, etc. The requester may be a third-party relative to the user, and be associated with the third-party computing system 150 as such. In some embodiments, the request may be received by the authorization processing circuit 124 from the third-party computing system 150.

After the provider computing system 110 receives the request at process 302, the provider computing system 110 may identify the data owner of the requested data element and notify the data owner of the request at process 304. That is, as described above, each of the data elements stored in the data vault 142 may be associated with a data owner. Therefore, upon receiving the request for the data element at process 302, the authorization processing circuit 124 may identify the data owner associated with the requested data element. In some embodiments, the data owner may be identified by an account number, a name, a pin, an internet protocol (IP) address of a user device 160 from which the data element was received, or any other PII associated with the data element. For instance, the data owner may be the user of the user device 160 and the provider computing system 110 (e.g., the alert engine 130) may route the request to the data owner via the client application 168.

At process 306, the provider computing system 110 may receive an approval of the request from the data owner. For instance, the data owner may review and approve the request via the client application 168. Based on the approval received from the data owner at process 306, the provider computing system 110 (e.g., the authorization processing circuit 124) may be configured to approve the request received at process 302 and add the approved request to a ledger at process 308.

At process 310, the provider computing system 110 (e.g., the data tagging engine 126) may be configured to tag each data element included in or associated with the request. In some instances, process 310 may include tagging a dataset as a whole. Additionally or alternatively, process 310 may include tagging individual data elements included in the dataset. Then, the individual (e.g., for the data elements individually) and combination of tags (e.g., for the dataset collectively) may be stored by the provider computing system 110 (e.g., in the data vault 142). In some embodiments, tagging the data at process 310 may include tagging the data with information relating to the request received at process 302. In this way, tagging the data may be a dynamic process. For instance, process 310 may include tagging the data with a tokenized requestor ID, a tokenized indication of permitted usage, etc.

After tagging the data at process 310, the provider computing system 110 may obtain the requested data (e.g., from the data vault 142) and provide the data to the data requestor at process 312a. Additionally or alternatively, the provider computing system 110 may be configured to approve access to the data vault 142 for the requestor of the data at process 312b after tagging the data at process 310. In some embodiments, an access point in time refers to the time when the data requestor can access the data (e.g., as provided at process 312b). The data elements may be tagged with an expiry condition (e.g., by the data tagging engine 126) such that upon receiving access to the data vault 142, the requestor may only have a limited amount of time to obtain the data. For example, the expiry condition may be applied to the data elements such that upon receiving access to the data vault 142, the data requestor is required to obtain the requested data within a predefined amount of time (e.g., one minute). In this way, the data requestor is not granted an excess of time to access the data vault 142 (e.g., during which time the data requestor may attempt to access unauthorized data elements, etc.).

Furthermore, in some instances, the data may remain in the data vault 142 and cannot be copied. Therefore, the requestor may use the data virtually. Virtual data use allows for the usage of the data through cloud computing, virtual machines, or online platforms without relying on physical hardware. Additionally or alternatively, in some instances, the requestor may use the data locally. Local data use allows for the usage of the data on physical devices such as computers, hard drives, or on-premise servers without requiring an internet connection. In some embodiments, the requestor may receive a pointer, rather than the data element itself. A pointer refers to a reference or address that directs to a specific location where data is stored, rather than holding the actual data itself. For instance, there may be an integration with the blockchain whereby the pointer is to the data and a hash of the data is used to ensure that the data has not been altered.

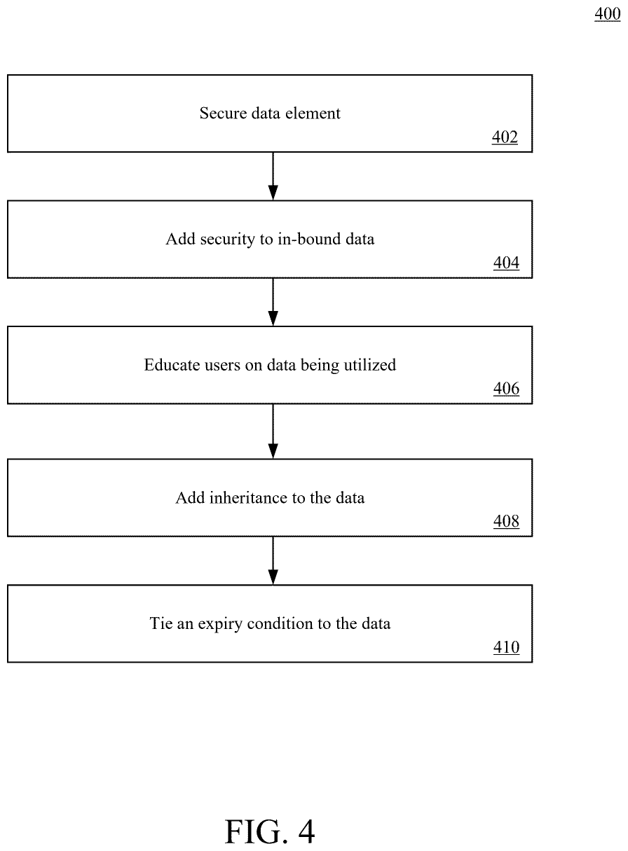

Referring to FIG. 4, a method 400 for performing lifecycle data management is shown, according to an example embodiment. Various operations of the method 400 may be conducted by the system 100 and particularly parts thereof (e.g., the provider computing system 110, the third-party computing system 150, the user device 160). It should be understood that not all method steps/processes may be performed to “complete” the method. Certain steps/processes may be omitted in other embodiments, and still fall within the scope of the present disclosure. In some instances, such a method for lifecycle management of data may be performed when requestors request data (e.g., at process 302 of method 300) to add an additional layer of security to the data being requested.

As a brief overview, the method 400 refers to a method of securing data elements. As described in greater detail below, data elements may be secured at a point of data creation and/or once the data elements are already stored in a database. Furthermore, securing the data elements using the method 400 includes educating users on data being utilized and security applied thereto. Inheritance may be added to the data to provide additional information, and in some instances an expiry condition may be tied to the data in order to prevent unauthorized access to the data. Thus, the method 400 provides a method of applying heightened security measures to data such that an immutable chain of custody is generated for the data.

At process 402, the provider computing system 110 (e.g., the data tagging engine 126) applies security to a data element. In some embodiments, securing the data element refers to tagging the data element (e.g., as described above with reference to the data tagging engine 126). In some embodiments, the provider computing system 110 may add the security at a point of data creation (e.g., when the data enters the data vault 142). In such instances, method 400 may include adding security to in-bound data at process 404. For example, adding security to the in-bound data may include encrypting the data while it is being transmitted to the data vault 142, sanitizing in-bound data (e.g., ensuring the data is properly formatted, free of malicious code, etc.), tagging the data based on permissions and restrictions defined by the data owner (e.g., stored in the user preference database 144, as described above), and so on. Additionally or alternatively, in the case of existing data in the data vault 142, the data tagging engine 126 may apply security to the existing data such that the existing data is secured (e.g., labeled) prior to usage.

At process 406, the provider computing system 110 educates users on the data being utilized. That is, the provider computing system 110 may be configured to recognize/detect the data, and then educate/assist the user regarding a certain kind of data. For example, the provider computing system 110 may be configured to recommend a level of security to apply to the data, use conditions to apply to the data (e.g., virtual use only, local use, etc.), permissions and restrictions to apply to the data, and so on, based on the type of data (e.g., PII, a phone number, an address, an email address, instant messaging (IM) information, intellectual property, an account number, policy information). As a more specific example, the provider computing system 110 may recognize that the data is a phone number and may suggest applying a first level of security to the data that is lower than a level of security that may be recommended for more sensitive information such as an account number.

At process 408, the provider computing system 110 adds inheritance to the data. Adding inheritance to data refers to structuring information in a way that allows certain attributes or properties to be passed down from a parent entity to child entities in a data family (e.g., dataset, data collection, etc.). In other words, adding inheritance to the data at process 408 refers to automatically labeling data based on parent data. For example, if the data vault 142 stores biometric information (e.g., the parent data), such as facial scan of the user, but does not include a fingerprint scan of the user (e.g., the child data), and the data vault 142 then receives the fingerprint scan of the user, attributes or properties (e.g., tags) associated with the biometric information of the user stored in the data vault 142 may be automatically applied to the fingerprint scan. Continuing with this example, if the user (e.g., the data owner) specifies that the user's biometric information may be used to authenticate the user when accessing a mobile application, but may not be used to verify payment information for a mobile transaction, such permissions and restrictions may be added (e.g., tagged) to the fingerprint scan when received by the data vault 142. Adding inheritance to the data provides technical benefits to data storage such as reducing duplication in the data vault 142, ensuring consistency across related data entities (e.g., various pieces of PII for a same data owner), improving scalability and organization, and simplifying updates by modifying a single parent structure, rather than each of the individual data elements in the data family.

In some embodiments, method 400 may include tying an expiry condition to the labeled data at process 410. As such, with the expiry condition, the provider computing system 110 (e.g., the data tracking engine 128) may be configured to maintain the lifecycle of the data. Furthermore, in this way, at the end-of-the-life cycle (e.g., once the expiry condition is met), the data may be destructed. For example, the expiry condition may provide for the data requestor to have access to the requested data for a predefined amount of time (e.g., 24 hours). Then, once the predefined amount of time has expired, the data tracking engine 128 may be configured to destruct the data. As another example, the expiry condition may provide for the data to be passed (e.g., change hands) no more than a predefined number of times (e.g., one time, five times, ten times, etc.). In this way, once the data has been passed the predefined number of times (e.g., the expiry condition has expired), the data tracking engine 128 may be configured to destruct the data.

Referring to FIG. 5, a GUI 500 is shown, according to an example embodiment. The GUI 500 may be generated by the provider computing system 110 for display on the user device 160. In other embodiments, the GUI 500 is generated by the client application 168. In some embodiments, the GUI 500 may be displayed to a user during a session with the client application 168. The session with the client application 168 may refer to an engagement/interaction with the client application 168. That is, the session may begin when a user successfully accesses the client application 168 using their authentication information. The session may end when a user exits/logs out of/closes the client application 168.

As shown, the GUI 500 may display a plurality of permissions and restrictions 505 regarding data usage to the user (e.g., data owner). More specifically, the permissions and restrictions 505 may include an expiry condition, data handling, a use condition, and so on. The expiry condition may refer to a time limit within which a requester is allowed to access the requested data once the request is authorized (e.g., by the authorization processing circuit 124 at process 308). For instance, the data owner may specify an expiry condition of five minutes, meaning the requestor is allotted five minutes to access the data once the request to access the data is granted. The data handling restriction may refer to a number of times the data may be permitted to switch hands between requestors. For instance, a user may choose a data handling condition of three passes, meaning the data may only be accessed by separate entities (e.g., “switch hands”) a maximum of three times before being notified (e.g., via GUI 600, as described below). The use condition restriction may refer to a restriction imparted on the use of certain data. for instance, the data owner may specify that the data is available for virtual use only. In some embodiments, the permissions and restrictions 505 displayed via the GUI 500 may be the restrictions and permissions regarding use of user data received at process 202 of method 200.

Referring to FIG. 6, a GUI 600 is shown, according to an example embodiment. In one embodiment, the GUI 600 may be generated by the provider computing system 110 for display on the user device 160. In other embodiments, the GUI 600 is generated by the client application 168. In some embodiments, the GUI 600 may be displayed to a user during a session with the client application 168. The session with the client application 168 may refer to an engagement/interaction with the client application 168. That is, the session may begin when a user successfully accesses the client application 168 using authentication information (e.g., at process 512 of method 400). The session may end when a user exits/logs out of/closes the client application 168.

More specifically, the GUI 600 may be configured to provide an alert 605 regarding unauthorized use of data to a data owner (e.g., a user associated with the user device 160). In some embodiments, the GUI 600 may be generated and the alert 605 provided upon the provider computing system 110 (e.g., the data tracking engine 128) identifying a violation of one of the permissions and restrictions 505 indicated via the GUI 500, as described above. For instance, as shown in FIG. 6, the alert 605 may include a notification that a user's PII has been handled five times. In such an instance, the data tracking engine 128 may identify that the data handling condition specified by the user indicates a maximum of three passes, and therefore may flag unauthorized use upon determining that the data owner's PII has been handled five times. Furthermore, the GUI 600 may include an option to at least one of delete the data (e.g., the PII) or update user preferences (e.g., the data handling condition).

Additionally or alternatively, the provider computing system 110 may be configured to perform a remedial action in response to identifying unauthorized use of the data. For instance, because the chain of custody of the data element is immutable, the alert engine 130 may be configured to identify a person/entity associated with potential misuse and alert authority of that entity. As another example, the authorization processing circuit 124 may be configured to remove certain data from being accessed from the data vault 142 for a predefined period of time. As yet another example, the data tracking engine 128 may be configured to monitor certain data associated with misuse for potential undesirable misuse (e.g., identity theft). Furthermore, where a data requestor is associated with low integrity values of requested data (e.g., due to the data requestor misusing data), the authorization processing circuit 124 may be configured to revoke a privilege of the data requestor to access the data vault 142 (e.g., for a predefined period of time, indefinitely, etc.).

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOC) circuits), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR), resistors, multiplexers, registers, capacitors, inductors, diodes, wiring, and so on.

The “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may include or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor), microprocessor, etc. In some embodiments, the one or more processors may be external to the apparatus, for example the one or more processors may be a remote processor (e.g., a cloud-based processor). Alternatively or additionally, the one or more processors may be internal and/or local to the apparatus. In this regard, a given circuit or components thereof may be disposed locally (e.g., as part of a local server, a local computing system) or remotely (e.g., as part of a remote server such as a cloud-based server). To that end, a “circuit” as described herein may include components that are distributed across one or more locations.

An exemplary system for implementing the overall system or portions of the embodiments might include a general-purpose computing devices in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions include, for example, instructions and data which cause a general-purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components), in accordance with the example embodiments described herein.

It should also be noted that the term “input devices,” as described herein, may include any type of input device including, but not limited to, a keyboard, a keypad, a mouse, joystick or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations may depend on the machine-readable media and hardware systems chosen and on designer choice. It is understood that all such variations are within the scope of the disclosure. Likewise, software and web implementations of the present disclosure could be accomplished with standard programming techniques with rule-based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and embodiment of the embodiments without departing from the scope of the present disclosure as expressed in the appended claims.

What is claimed is:

1. A computing system for imparting security to a data element, the computing system comprising:
at least one processing circuit having at least one processor coupled to at least one memory, the at least one memory storing instructions thereon that, when executed by the at least one processor, cause the at least one processing circuit to perform operations comprising:
receiving the data element;
receiving a request to access the data element from a data requestor;
tagging the data element with a label regarding the request to access the data element;
determining an expected usage of the data element based on the request and storing information regarding the expected usage in the at least one memory;
providing the data requestor with access to the data element;
receiving information regarding an actual usage of the data element by the data requestor;
comparing the information regarding the actual usage to the information regarding the expected usage stored by the at least one memory;
in response to determining that the actual usage of the data element complies with the expected usage of the data element, generating and providing a notification regarding a compliance of the actual usage of the data element; and
in response to determining that the actual usage of the data element does not comply with the expected usage of the data element, generating and providing a notification regarding non-compliance of the actual usage of the data element.

2. The computing system of claim 1, wherein the instructions, when executed by the at least one processor, further cause the at least one processing circuit to perform operations comprising:
tagging the data element with an expiry condition such that the data requestor is provided with a predefined limited amount of time to access the data element, wherein the predefined limited amount of time is defined by the expiry condition.

3. The computing system of claim 1, wherein the instructions, when executed by the at least one processor, further cause the at least one processing circuit to perform operations comprising tagging the data element with an integrity value in response to determining that the actual usage of the data element complies with the expected usage of the data element or in response to determining that the actual usage of the data element does not comply with the expected usage of the data element.

4. The computing system of claim 3, wherein the integrity value is relatively higher in response to determining that the actual usage of the data element complies with the expected usage of the data element than in response to determining that the actual usage of the data element does not comply with the expected usage of the data element.

5. The computing system of claim 3, wherein the expected usage of the data element comprises a first set of expected usages, and wherein the instructions, when executed by the at least one processor, further cause the at least one processing circuit to perform operations comprising:
determining that the actual usage of the data element does not comply with the first set of expected usages;
tagging the data element with a relatively low integrity value in response to determining that the actual usage of the data element does not comply with the first set of expected usages; and
determining a second set of expected usages of the data element based on the relatively low integrity value, wherein the second set of expected usages is smaller than the first set of expected usages.

6. The computing system of claim 1, wherein the data element includes at least one of personal identifying information (PII), a phone number, an address, an email address, or an account number.

7. The computing system of claim 1, wherein the request to access the data element further comprises contextual information regarding the request to access the data element, the contextual information comprising at least one of an identity of the data requestor, a reason for the request, or an estimated length of time for use of the data element.

8. The computing system of claim 1, wherein the expected usage of the data element is further determined using at least one of a permission or a restriction regarding the data element, the at least one of the permission or the restriction being defined by a data owner of the data element.

9. The computing system of claim 1, wherein the instructions, when executed by the at least one processor, further cause the at least one processing circuit to perform operations comprising:
tagging, using a generative artificial intelligence model, the data element at an access point in time, a usage point in time, or a check-in point in time;
tracking the data element to determine compliance at the access point in time, the usage point in time, and the check-in point in time; and
generating a tracking map for the data element, wherein the tracking map represents the compliance at the access point in time, the usage point in time, and the check-in point in time.

10. The computing system of claim 1, wherein the instructions, when executed by the at least one processor, further cause the at least one processing circuit to perform operations comprising:
applying one or more dummy labels to the data element, wherein the one or more dummy labels are configured to obfuscate information associated with the data element;
tracking the actual usage of the data element by tracking the one or more dummy labels; and
receiving the information regarding the actual usage of the data element by the data requestor based on tracking the one or more dummy labels.

11. A method for imparting security to a data element, the method comprising:
receiving, by a computing system, the data element;
receiving, by the computing system, a request to access the data element from a data requestor;
tagging, by the computing system, the data element with a label regarding the request to access the data element;
determining, by the computing system, an expected usage of the data element based on the request and storing information regarding the expected usage in at least one memory of the computing system;
providing, by the computing system, the data requestor with access to the data element;
receiving, by the computing system, information regarding an actual usage of the data element by the data requestor;
comparing, by the computing system, the information regarding the actual usage to the information regarding the expected usage stored by the at least one memory;
in response to determining that the actual usage of the data element complies with the expected usage of the data element, generating and providing, by the computing system, a notification regarding a compliance of the actual usage of the data element; and
in response to determining that the actual usage of the data element does not comply with the expected usage of the data element, generating and providing, by the computing system, a notification regarding non-compliance of the actual usage of the data element.

12. The method of claim 11, wherein the method further comprises:
tagging, by the computing system, the data element with an expiry condition such that the data requestor is provided with a predefined limited amount of time to access the data element, wherein the predefined limited amount of time is defined by the expiry condition.

13. The method of claim 11, wherein the method further comprises:
tagging, by the computing system, the data element with an integrity value in response to determining that the actual usage of the data element complies with the expected usage of the data element or in response to determining that the actual usage of the data element does not comply with the expected usage of the data element.

14. The method of claim 13, wherein the integrity value is relatively higher in response to determining that the actual usage of the data element complies with the expected usage of the data element than in response to determining that the actual usage of the data element does not comply with the expected usage of the data element.

15. The method of claim 13, wherein the expected usage of the data element comprises a first set of expected usages, and wherein the method further comprises:
determining, by the computing system, that the actual usage of the data element does not comply with the first set of expected usages;
tagging, by the computing system, the data element with a relatively low integrity value in response to determining that the actual usage of the data element does not comply with the first set of expected usages; and
determining, by the computing system, a second set of expected usages of the data element based on the relatively low integrity value, where the second set of expected usages is smaller than the first set of expected usages.

16. The method of claim 11, wherein the data element includes at least one of personal identifying information (PII), a phone number, an address, an email address, or an account number.

17. The method of claim 11, wherein tagging the data element comprises at least one of:
tagging the data element with the label such that the data requestor receives the label when accessing the data element; or
tagging the data element with the label such that the label is stored in the computing system, wherein the data requestor does not receive the label when accessing the data element.

18. The method of claim 11, wherein the method further comprises:
tagging, by the computing system using a generative artificial intelligence model, the data element at an access point in time, a usage point in time, or a check-in point in time;
tracking, by the computing system, the data element to determine compliance at the access point in time, the usage point in time, and the check-in point in time; and
generating, by the computing system, a tracking map for the data element, wherein the tracking map represents the compliance at the access point in time, the usage point in time, and the check-in point in time.

19. The method of claim 11, wherein the method further comprises:
applying, by the computing system, one or more dummy labels to the data element, wherein the one or more dummy labels are configured to obfuscate information associated with the data element;
tracking, by the computing system, the actual usage of the data element by tracking the one or more dummy labels; and
receiving the information regarding the actual usage of the data element by the data requestor based on tracking the one or more dummy labels.

20. A non-transitory computer readable medium including instructions stored thereon that, when executed by one or more processors, cause the one or more processors to perform operations comprising:
receiving a data element;
receiving a request to access the data element from a data requestor;
tagging the data element with a label regarding the request to access the data element;
determining an expected usage of the data element based on the request and storing information regarding the expected usage in at least one memory;
providing the data requestor with access to the data element;
receiving information regarding an actual usage of the data element by the data requestor;
comparing the information regarding the actual usage to the information regarding the expected usage;
in response to determining that the actual usage of the data element complies with the expected usage of the data element, generating and providing a notification regarding a compliance of the actual usage of the data element; and
in response to determining that the actual usage of the data element does not comply with the expected usage of the data element, generating and providing a notification regarding non-compliance of the actual usage of the data element.
